(19) United States
(12) Patent Application Publication
(10) Pub. No.: US 2009/0239046 A1
(43) Pub. Date: Sep. 24, 2009

(54) Method for Printing a Surface

(76) Inventors: Michael Vankov, Schmitten (DE); Harald De Buhr, Kronberg (DE)

Correspondence Address: FISH & RICHARDSON PC, P.O. BOX 1022, MINNEAPOLIS, MN, 55440-1022, US

(21) Appl. No.: 12/293,137

(22) PCT Filed: Feb. 28, 2007
(86) PCT No.: PCT/EP2007/001709

§ 371 Date: Sep. 16, 2008

(30) Foreign Application Priority Data
Mar. 16, 2006 (DE) 10 2006 011 983.5

(51) Int. Cl. B32B 7/06; B32B 37/12; A46B 9/04

(52) U.S. Cl. 428/200; 156/230; 15/167.1

(57) ABSTRACT

A hot-film embossing method for printing a surface and a corresponding embossing film, in particular for printing a plastic surface. The embossing film has at least one patterned layer or ink layer and one melt layer. The embossing film is pressed against the surface by means of an embossing ram, whereby a heat input into the melt layer is achieved by means of high-frequency radiation.

### CROSS-REFERENCE TO RELATED APPLICATIONS

This application is a national phase application under 35 U.S.C. § 371 of PCT International Application No. PCT/EP 2007/001709, filed Feb. 28, 2007, which claims priority to German Application No. 10 2006 011983.5, filed Mar. 16, 2006. The contents of each of these applications are incorporated herein by reference in their entirety.

### TECHNICAL FIELD

The invention relates to a method for printing a surface, in particular a plastic surface, by hot embossing, in particular hot-film embossing, and a film backing and a toothbrush.

### BACKGROUND

For decorating and printing plastic surfaces, hot embossing methods are used. In hot-film embossing, for example, a prefabricated embossing film comprised of multiple layers is used, carrying the information that is to be applied to the surface, e.g., in the form of unicolored or multicolor images, characters, logos and the like.

The ink pigments contained in an ink layer of the embossing film are transferred from the film to the surface to be printed, which requires a supply of heat. This serves to release the ink layer from the embossing film and also to secure the ink layer on the plastic surface to be printed.

The heat is input in general via a heatable hot embossing ram. The heat emanating from this stamp is passed through the entire film when printing the surface.

DE 103 18 909 A1, for example, discloses the fact that the hot embossing ram comprises a heatable aluminum backing with a silicone coating for equalizing irregularities in the plastic part to be printed. Due to the poor heat transfer properties of silicone, the aluminum backing must be heated to relatively high temperatures, so that the heat input into the embossing film is sufficient for printing the surface. Consequently, there is often a relatively high temperature gradient between the aluminum backing and the silicone outer surface of the hot embossing ram.

Temperature regulation of the hot embossing ram is of course relatively inert due to the thermal conduction properties of the materials to be heated. A high temperature gradient in the area of the silicone coating is reflected in a short lifetime of this coating.

### SUMMARY

In one aspect, a method for printing a surface, in particular a plastic surface, is a hot-film embossing method in which the embossing film has at least one ink layer and at least one melt layer. To apply an ink layer to the surface that is to be printed, an embossing ram is used, pressing he embossing film and thus also the ink layer that carries the information against the surface that is to be printed.

The at least one melt layer is designed as a hot-melt adhesive layer or as a release layer. Both layers, namely the release layer and the hot-melt adhesive layer, melt during the embossing operation due to the input of heat, so that the pattern layer or ink layer is secured on the substrate to be printed and a backing film of the embossing film is released from the pattern attached to the surface.

In some implementations, the heat input into the at least one hot-melt layer is achieved by means of high-frequency radiation. At least the hot-melt layer is designed so that it undergoes heating when exposed to high-frequency radiation. In this way, targeted input of heat into the layer to be melted in the embossing process can be achieved without requiring a heatable embossing ram for this purpose.

Here again, the heat must not be supplied to the embossing film from the outside. Due to irradiation with high-frequency waves, local heating is supplied directly into the layers that are to be heated. Depending on the radiation exposure, uniform and rapid heating of the hot-melt layer can thus be achieved with at the same time minimal stress on the backing film, the embossing device and the substrate that is to be printed.

In addition, by using high-frequency radiation, it is possible to achieve suitable heating of the melt layer. By direct introduction of the thermal energy into the melt layer, the embossing process can be made completely independent of the other materials and the geometry of the embossed film, in particular its thickness. Furthermore, the targeted and more controllable introduction of thermal energy into the melt layer ultimately leads to better attachment and adhesion of the pattern layer or ink layer to the plastic surface.

According to a first advantageous embodiment, metal particles are added to the melt layer. Such an addition already takes place, for example, during the production of the embossing film, so that the metal particles are already present inside the embossing film before the actual embossing operation. The melt layer, which may be designed both as a hot-melt adhesive layer and as a release layer, experiences almost instantaneous heating in the HF field due to the interaction of the metal particles with the high-frequency (HF) radiation according to the distribution of the metal particles in the layer.

According to another embodiment, the metal particles are distributed essentially uniformly in the melt layer. This uniform distribution of metal particles or metal pigments with uniform action of HF radiation leads to uniform heating of the melt layer.

According to another embodiment, the melt layer is heated to a temperature between 30° C. and 250° C., preferably to a temperature between 80° C. and 120° C. Owing to the targeted and direct input of heat into the melt layer, the embossing ram may be designed as a so-called cold embossing ram, i.e., not being actively heatable.

Thermal conduction effects within the embossing film may therefore be essentially disregarded, so that a predetermined temperature can be adjusted accurately based only on the radiation power, the duration of radiation and the properties of the melt layer, in particular the density of the metal particles contained in it. Measurement of a temperature of the melt layer during the embossing process as part of process control can therefore be eliminated in a manner that saves on costs.

According to another aspect, the surface to be printed is part of a toothbrush made of plastic. The method for printing a plastic surface is therefore provided for printing toothbrushes.

According to another aspect, an embossing film for printing a surface, in particular a plastic surface, is featured. The embossing film has at least one pattern layer or ink layer to be applied to the surface and has at least one melt layer, whereby at least the melt layer contains metal particles that can be heated by high-frequency radiation.

In addition, a toothbrush with which the handle in particular is printed according to the above process features is described.

Advantages of the method described herein include simplification and optimization of a hot-film embossing process for printing plastic surfaces, and a film backing and a toothbrush printed accordingly. Furthermore, stress on the material of the embossing ram as well as the surface to be printed can be minimized. As described herein, available cycle times and embossing times may be shortened, so that the entire embossing operation can be optimized with regard to cost and time. In addition, better adhesion of the decoration and/or the pattern or image to the plastic surface that is to be printed can be achieved.

Additional goals, advantages and features and advantageous possible applications are derived from the following description of an exemplary embodiment on the basis of the drawings. All the features described here and/or illustrated in the figures form the subject matter of the present description, even independently of the patent claims or their reference back to previous claims.

### BRIEF DESCRIPTION OF THE DRAWINGS

FIG. 1 shows an embossing ram, an embossing film and a substrate in cross section.

### DETAILED DESCRIPTION

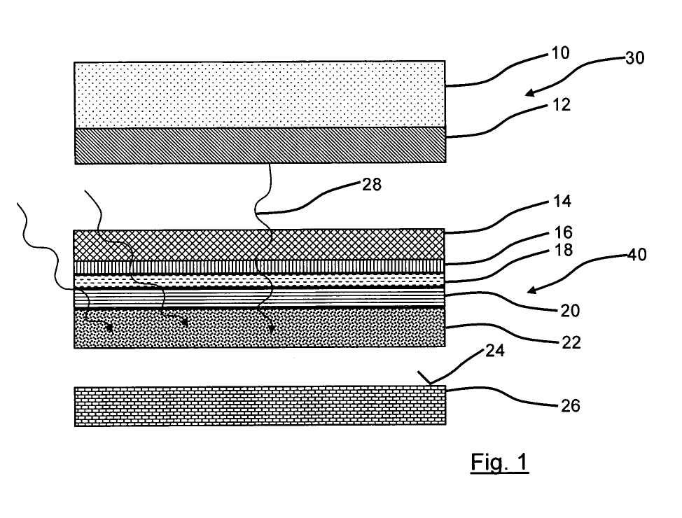

The embossing ram 30 illustrated in FIG. 1 has a backing 10, preferably made of aluminum, with a silicone coating 12, which is provided for equalizing irregularities in the substrate 26 that is to be printed.

The embossing film 40 consists of multiple layers, namely backing film 14, release layer 16, clear lacquer layer 18, ink or patterned layer 20 and hot-melt adhesive layer 22. At least the hot-melt adhesive layer 22 but preferably also the release layer 16 are melt layers in the sense of the present embodiment.

In the hot press operation, the embossing film 40 is printed by means of the embossing ram 30 on the surface 24 of the substrate 26 that is to be printed. The heat input required for melting the hot-melt adhesive layer 22 and release layer 16 is accomplished here via high-frequency radiation 28, which interacts with the metal particles present in the layers 16 and 22 and thus leads to a targeted and local heating of these layers which are provided for melting.

The heating of the hot-melt adhesive layer 22 leads to joining and securing of the patterned layer or ink layer 20 at the surface 24 of the substrate 26, which can be made of polypropylene.

The heating of the release layer 16 results in the backing film 14 being releasable from the ink layer and/or pattern layer 20 and a clear lacquer layer 18 provided above it. At the end of the embossing operation, the clear lacquer layer 18 thus forms a surface of the substrate 26 that is to be printed and protects the ink layer or patterned layer 20.

1-6. (canceled)

7. A method of applying an image to a surface, the method comprising:
(a) pressing an embossing film against a surface, the embossing film comprising:
(i) a backing film;
(ii) a patterned layer or an ink layer secured to the backing film; and
(iii) a melt layer secured to the backing film, the melt layer comprising metal particles distributed in the melt layer; and
(b) melting the melt layer by heating the particles with high-frequency radiation, thereby securing the patterned layer or ink layer to the surface; and
(c) releasing the backing film from the surface.

8. The method according to claim 7, wherein the melt layer is a hot-melt adhesive layer, and the patterned layer or ink layer is between the hot-melt adhesive layer and the backing film.

9. The method according to claim 7, wherein the melt layer is a release layer, and the release layer is between the backing film and the patterned layer or ink layer.

10. The method according to claim 7, further comprising an additional melt layer, wherein a first one of the melt layers is a hot-melt adhesive layer and a second one of the melt layers is a release layer, wherein the release layer is between the backing film and the patterned layer or ink layer, and the patterned layer or ink layer is between the hot-melt adhesive layer and the release layer.

11. The method according to claim 10, wherein the release layer comprises metal particles distributed in the release layer.

12. The method according to claim 7, wherein the metal particles are distributed essentially uniformly in the melt layer.

13. The method according to claim 7, wherein the melt layer is heated to a temperature between 30° C. and 250° C. to melt the melt layer.

14. The method according to claim 13, wherein the melt layer is heated to a temperature between 80° C. and 120° C. to melt the melt layer.

15. The method according to claim 7, wherein the embossing film further comprises a lacquer layer between the patterned or ink layer and the release layer.

16. The method according to claim 7, wherein the surface is part of a toothbrush.

17. The method according to claim 7, wherein the surface is made of plastic.

18. The method according to claim 7, wherein pressing the backing film against the surface comprises compressing the backing film against the surface with an embossing ram.

19. An embossing film comprising:
(a) a backing layer
(b) a patterned layer or ink layer secured to the backing layer and configured to be applied to a surface; and
(c) a melt layer secured to the backing layer, the melt layer comprising metal particles distributed in the melt layer, wherein the metal particles are heatable by high-frequency radiation.

20. The embossing film according to claim 19, wherein the patterned layer or ink layer is configured to be applied to a plastic surface.

21. The embossing film according to claim 19, further comprising an additional melt layer comprising metal particles heatable by high-frequency radiation, wherein the patterned layer or ink layer is sandwiched between the melt layers.

22. A toothbrush comprising a patterned layer or ink layer secured to a surface of the toothbrush with a melt-adhered layer comprising a distribution of metal particles.

23. The toothbrush according to claim 22, wherein the metal particles are distributed uniformly in the melt-adhered layer.

24. The toothbrush according to claim 22, wherein the surface of the toothbrush to which the patterned layer or ink layer is secured comprises plastic.

25. The toothbrush according to claim 22, further comprising a clear lacquer layer on top of the patterned layer or ink layer.
